(19) United States
(12) Patent Application Publication
(10) Pub. No.: US 2009/0196814 A1
(43) Pub. Date: Aug. 6, 2009

(54) One electron atom catalysis, increased binding energy compounds, and applications thereof

(75) Inventor: Randell L. Mills, Cranbury, NJ (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: BlackLight Power, Inc.

(21) Appl. No.: 12/213,205

(22) Filed: Jun. 16, 2008

Related U.S. Application Data
(63) Continuation of application No. 09/669,877, filed on Sep. 27, 2000, now abandoned.
(60) Provisional application No. 60/156,942, filed on Sep. 30, 1999.

(51) Int. Cl. C01B 23/00; C22C 24/00; C22C 25/00; B01J 8/00

(52) U.S. Cl. 423/262; 420/400; 420/401; 423/659

(57) ABSTRACT

Provided is a compound having at least one neutral, positive or negative increased binding energy species formed from a one-electron atom having an atomic mass of at least four and at least one other element. The increased binding energy species has a binding energy greater than the binding energy of the corresponding ordinary species, or greater than the binding energy of any species for which the corresponding ordinary species is unstable or is not observed because the ordinary increased binding energy species' binding energy is less than a thermal energy at ambient conditions, or is negative.

### I. INTRODUCTION

1. Field of the Invention

This invention relates to novel catalytic reactions of one electron atoms to form compositions of matter comprising new forms of one electron atoms such as He⁺.

2. Background of the Invention

Hydrinos

A hydrogen atom having a binding given by

$$Binding Energy = \frac{13.6 eV}{{( \frac{1}{p} )}^{2}} \qquad ( 1 )$$

where p is an integer greater than 1, preferably from 2 to 200, is disclosed in Mills, R., The Grand Unified Theory of Classical Ouantum Mechanics, January 1999 Edition (“'99 Mills GUT”), provided by BlackLight Power, Inc., 493 Old Trenton Road, Cranbury; N.J., 08512; and in prior PCT applications PCT/US98/14029; PCT/US96/07949; PCT/US94/02219; PCT/US91/18496; PCT/US90/1998; and prior U.S. patent application Ser. No. 09/225,687, filed on Jan. 6, 1999; Ser. No. 60/095,149, filed Aug. 3, 1998; Ser. No. 60/101,651, filed Sep. 24, 1998; Ser. No. 60/105,752, filed Oct. 26, 1998; Ser. No. 60/113,713, filed Dec. 24, 1998; Ser. No. 60/123,835, filed Mar. 11, 1999; Ser. No. 60/130,491, filed Apr. 22, 1999; Ser. No. 60/141,036, filed Jun. 29, 1999; Ser. No. 09/009,294 filed Jan. 20, 1998; Ser. No. 09/111,160 filed Jul. 7, 1998; Ser. No. 09/111,170 filed Jul. 7, 1998; Ser. No. 09/111,016 filed Jul. 7, 1998; Ser. No. 09/111,003 filed Jul. 7, 1998; Ser. No. 09/110,694 filed Jul. 7, 1998; Ser. No. 09/110,717 filed Jul. 7, 1998; Ser. No. 60/053,378 filed Jul. 22, 1997; Ser. No. 60/068,913 filed Dec. 29, 1997; Ser. No. 60/090,239 filed Jun. 22, 1998; Ser. No. 09/009,455 filed Jan. 20, 1998; Ser. No. 09/110,678 filed Jul. 7, 1998; Ser. No. 60/053,307 filed Jul. 22, 1997; Ser. No. 60/068,918 filed Dec. 29, 1997; Ser. No. 60/080,725 filed Apr. 3, 1998; Ser. No. 09/181,180 filed Oct. 28, 1998; Ser. No. 60/063,451 filed Oct. 29, 1997; Ser. No. 09/008,947 filed Jan. 20, 1998; Ser. No. 60/074,006 filed Feb. 9, 1998; Ser. No. 60/080,647 filed Apr. 3, 1998; Ser. No. 09/009,837 filed Jan. 20, 1998; Ser. No. 08/822,170 filed Mar. 27, 1997; Ser. No. 08/592,712 filed Jan. 26, 1996; Ser. No. 08/467,051 filed on Jun. 6, 1995; Ser. No. 08/416,040 filed on Apr. 3, 1995; Ser. No. 08/467,911 filed on Jun. 6, 1995; Ser. No. 08/107,357 filed on Aug. 16, 1993; Ser. No. 08/075,102 filed on Jun. 11, 1993; Ser. No. 07/626,496 filed on Dec. 12, 1990; Ser. No. 07/345,628 filed Apr. 28, 1989; Ser. No. 07/341,733 filed Apr. 21, 1989 the entire disclosures of which are all incorporated herein by reference (hereinafter “Mills Prior Publications”). The binding energy, of an atom, ion or molecule, also known as the ionization energy, is the energy required to remove one electron from the atom, ion or molecule.

A hydrogen atom having the binding energy given in Eq. (1) is hereafter referred to as a hydrino atom or hydrino. The designation for a hydrino of radius

$$\frac{{a}_{H}}{p}$$

were a_{H} is the radius of an ordinary hydrogen atom and p is an integer, is

$$H [ \frac{{a}_{H}}{p} ] .$$

A hydrogen atom with a radius a_{H} is hereinafter referred to as “ordinary hydrogen atom” or “normal hydrogen atom.” Ordinary atomic hydrogen is characterized by its binding energy of 13.6 eV.

Hydrinos are formed by reacting an ordinary hydrogen atom with a catalyst having a net enthalpy of reaction of about

m·27.2 eV (2)

where m is an integer. This catalyst has also been referred to as an energy hole or source of energy hole in Mills earlier filed patent applications. It is believed that the rate of catalysis is increased as the net enthalpy of reaction is more closely matched to m 27.2 eV. It has been found that catalysts having a net enthalpy of reaction within ±10%, preferably ±5%, of m·27.2 eV are suitable for most applications.

This catalysis releases energy from the hydrogen atom with a commensurate decrease in size of the hydrogen atom, rₙ=na_{H}. For example, the catalysis of H(n=1) to H(n=½) releases 40.8 eV, and the hydrogen radius decreases from a_{H} to

$$\frac{1}{2} {a}_{H} .$$

One such catalytic system involves potassium. The second ionization energy of potassium is 31.63 eV; and K⁺ releases 4.34 eV when it is reduced to K. The combination of reactions K⁺ to K²⁺ and K⁺ to K, then, has a net enthalpy of reaction of 27.28 eV, which is equivalent to m=1 in Eq. (2).

$$\begin{matrix}27.28 eV + {K}^{+} + {K}^{+} + H [ \frac{{a}_{H}}{p} ] -> K + {K}^{2 +} + H [ \frac{{a}_{H}}{( p + 1 )} ] + [ {( p + 1 )}^{2} - {p}^{2} ] \times 13.6 eV & ( 3 ) \\ K + {K}^{2 +} -> {K}^{+} + {K}^{+} + 27.28 eV & ( 4 )\end{matrix}$$

The overall reaction is

$$H [ \frac{{a}_{H}}{p} ] -> H [ \frac{{a}_{H}}{( p + 1 )} ] + [ {( p + 1 )}^{2} ] \times 13.6 eV \qquad ( 5 )$$

Rubidium ion (Rb⁺) is also a catalyst because the second ionization energy of rubidium is 27.28 eV. In this case, the catalysis reaction is

$$\begin{matrix}27.28 eV + {Rb}^{+} + H [ \frac{{a}_{H}}{p} ] -> {Rb}^{2 +} + {e}^{-} + H [ \frac{{a}_{H}}{( p + 1 )} ] + [ {( p + 1 )}^{2} - {p}^{2} ] \times 13.6 eV & ( 6 ) \\ {Rb}^{2 +} -> {e}^{-} -> {Rb}^{+} + 27.28 eV & ( 7 )\end{matrix}$$

And, the overall reaction is

$$H [ \frac{{a}_{H}}{p} ] -> H [ \frac{{a}_{H}}{( p + 1 )} ] + [ {( p + 1 )}^{2} - {p}^{2} ] \times 13.6 eV \qquad ( 8 )$$

The energy given off during catalysis is much greater than the energy lost to the catalyst. The energy released is large as compared to conventional chemical reactions. For example, when hydrogen and oxygen gases undergo combustion to form water

$${H}_{2} ( g ) + [ \frac{1}{2} ] {O}_{2} ( g ) -> {H}_{2} O ( l ) \qquad ( 9 )$$

the known enthalpy of formation of water is ∇H_{f}=−286 kJ/mole or 1.48 eV per hydrogen atom. By contrast, each (n=1) ordinary hydrogen atom undergoing catalysis releases a net of 40.8 eV. Moreover, further catalytic transitions may occur:

$$n = \frac{1}{2} -> \frac{1}{3} , \frac{1}{3} -> \frac{1}{4} , \frac{1}{4} -> \frac{1}{5} ,$$

and so on. Once catalysis begins, hydrinos autocatalyze further in a process called disproportionation. This mechanism is similar to that of an inorganic ion catalysis. But, hydrino catalysis should have a higher reaction rate than that of the inorganic ion catalyst due to the better match of the enthalpy to m·27.2 eV.

The catalytic reaction of hydrogen or hydrino atoms to lower energy states by reacting an ordinary hydrogen atom or a hydrino atom with a catalyst having a net enthalpy of reaction of about m 27.2 eV where m is an integer may be generalized to all one electron atoms. Other than hydrogen all electron atoms comprising a nucleus and one electron are ions. Conventionally they are referred to as one electron atoms; thus, any species which is neutral or charged having a nucleus and one electron is hereafter referred to as a one electron atom.

### II. SUMMARY OF THE INVENTION

An objective of the present invention is to provide novel catalytic reactions to form lower-energy state one electron atoms. The reactant catalyzed to a lower-energy state is a one electron atom such as He⁺, Li²⁺, Be³⁺, etc. which is reacted with a catalyst having a net enthalpy of reaction of about m 27.2 eV where m is an integer. The catalysis may involve a mixture of one electron atoms and lower-energy state one electron atoms which may serve as catalysts or reactants. For example a hydrino atom may provide a net enthalpy of reaction of about m·27.2 eV where m is an integer in an ionization reaction to serve as a catalyst for He⁺ or lower-energy He⁺ to undergo a transition to a lower energy state. Preferably, the catalyst is neutral.

Another objective is to provide an increased binding energy one electron atom and compounds comprising at least one increased binding energy one electron atom.

### III. BRIEF DESCRIPTION OF THE DRAWINGS

FIG. 1 is a schematic drawing of a reactor in accordance with the present invention;

FIG. 2 is a schematic drawing of a gas cell reactor in accordance with the present invention;

FIG. 3 is a schematic drawing of a gas discharge cell reactor in accordance with the present invention;

FIG. 4 is a schematic drawing of a plasma torch cell reactor in accordance with the present invention, and

FIG. 5 is a schematic drawing of another plasma torch cell reactor in accordance with the present invention.

### IV. DETAILED DESCRIPTION OF THE INVENTION

An objective of the present invention is to provide novel catalytic reactions to form a lower-energy state one electron atoms. The reactant catalyzed to a lower-energy state is a one electron atom such as He⁺, Li²⁺, Be³⁺, etc. which is reacted with a catalyst having a net enthalpy of reaction of about m 27.2 eV where m is an integer. The catalysis may involve a mixture of one electron atoms and lower-energy state one electron atoms which may serve as catalysts or reactants. For example a hydrino atom may provide a net enthalpy of reaction of about m 27.2 eV where m is an integer in an ionization reaction to serve as a catalyst for He⁺ or lower-energy He⁺ to undergo a transition to a lower energy state. Preferably, the catalyst is neutral.

Another objective is to provide compounds that can be used in batteries, fuel cells, cutting materials, light weight high strength structural materials and synthetic fibers, corrosion resistant coatings, heat resistant coatings, xerographic compounds, proton source, photoluminescent compounds, phosphors for lighting, ultraviolet and visible light source, photoconductors, photovoltaics, chemiluminescent compounds, fluorescent compounds, optical coatings, optical filters, extreme ultraviolet laser media, fiber optic cables, magnets and magnetic computer storage media, superconductors, and etching agents, masking agents, agents to purify silicon, dopants in semiconductor fabrication, cathodes for thermionic generators, fuels, explosives, and propellants.

Another objective is to provide compounds which may be useful in chemical synthetic processing methods and refining methods.

A further objective is to provide a compound having a selective reactivity in forming bonds with specific isotopes to provide a means to purify desired isotopes of elements. The method is described in Mills Prior Publications (e.g. PCT/US98/14029 and prior U.S. patent application Ser. No. 09/225,687, filed on Jan. 6, 1999) which are herein incorporated by reference except that at least one selected from the group of an increased binding energy one electron atom, an increased binding energy one electron atom species, an increased binding energy species, and an increased binding energy compound of the present invention replaces an increased binding energy hydrogen species or an increased binding energy hydrogen compound. The same applies to other applications described therein to the corresponding applications of the present invention.

The above objectives and other objectives are achieved by novel compounds and molecular ions comprising

(a) at least one, one electron atom (hereinafter “increased binding energy one electron atom”) having a binding energy greater than the binding energy of the corresponding ordinary one electron atom; and

(b) at least one other element. The compounds of the invention are hereinafter referred to as “increased binding energy compounds”.

By “other element” in this context is meant an element other’ than an increased binding energy one electron atom. Thus, the other element can be an ordinary one electron atom, increased binding energy hydrogen species of Mills Prior Publications which are herein incorporated by reference, or any element other than a one electron atom. In one group of compounds, the other element and the increased binding energy one electron atom are neutral. In another group of compounds, the other element and increased building energy one electron atom are charged such that the other element provides the balancing charge to form a neutral compound. The former group of compounds is characterized by molecular and coordinate bonding; the latter group is characterized by ionic bonding.

Also provided are novel compounds and molecular ions comprising

(a) a plurality of one electron atoms (hereinafter “increased binding energy one electron atoms”) having a binding energy greater than the binding energy of the corresponding ordinary one electron atoms; and

(b) optionally one other element. The compounds of the invention are hereinafter referred to as “increased binding energy compounds”.

Also provided are novel compounds and molecular ions comprising

(a) at least one neutral. positive, or negative one electron atom species (hereinafter “increased binding energy one electron atom species”) having a binding energy
(i) greater than the binding energy of the corresponding ordinary one electron atom species, or
(ii) greater than the binding energy of anyone electron atom species for which the corresponding ordinary one electron atom species is unstable or is not observed because the ordinary one electron atom species' binding energy is less than thermal energies at ambient conditions (standard temperature and pressure, STP), or is negative; and

(b) at least one other element. The compounds of the invention are hereinafter referred to as “increased binding energy compounds”.

By “other element” in this context is meant an element other than an increased binding energy one electron atom species. Thus, the other element can be an ordinary one electron atom species, increased binding energy hydrogen species of Mills Prior Publications which are herein incorporated by reference, or any element other than a one electron atom. In one group of compounds, the other element and the increased binding energy one electron atom species are neutral. In another group of compounds, the other element and increased binding energy one electron atom species are charged such that the other element provides the balancing charge to form a neutral compound. The former group of compounds is characterized by molecular and coordinate bonding; the latter group is characterized by ionic bonding.

Also provided are novel compounds and molecular ions comprising

(a) a plurality of neutral, positive, or negative one electron atom species (hereinafter “increased binding energy one electron atom species”) having a binding energy
(i) greater than the binding energy of the corresponding ordinary one electron atom species, or
(ii) greater than the binding energy of anyone electron atom species for which the corresponding ordinary one electron atom species is unstable or is not observed because the ordinary one electron atom species' binding energy is less than thermal energies at ambient conditions (standard temperature and pressure, STP), or is negative; and

(b) optionally one other element. The compounds of the invention are hereinafter referred to as “increased binding energy compounds”.

The increased binding energy one electron atom species can be formed by reacting one or more increased binding energy one electron atoms with one or more of an increased binding energy one electron atom, an increased binding energy one electron atom species, a compound containing at least one of said increased binding energy one electron atom species, and at least one other atom, molecule, or ion other than an increased binding energy one electron atom species. In the case that an increased binding energy one electron atom or increased binding energy one electron atom species reacts with one or more electrons, a positive, neutral, or negative species is formed (hereinafter “increased binding energy species”).

Also provided are novel compounds and molecular ions comprising

(a) at least one neutral, positive, or negative species (hereinafter “increased binding energy species”) having a total energy
(i) greater than the total energy of the corresponding ordinary species, or
(ii) greater than the total energy of any species for which the corresponding ordinary species is unstable or is not observed because the ordinary species' total energy is less than thermal energies at ambient conditions, or is negative; and

(b) at least one other element.

The total energy of the increasing binding energy species is the sum of the energies to remove all of the electrons from the increasing binding energy species. The increasing binding energy species according to the present invention has a total energy greater than the total energy of the corresponding ordinary species. The species having an increased total energy according to the present invention is also referred to as an “increased binding energy species” even though some embodiments of the species having an increased total energy may have a first electron binding energy less that the first electron binding energy of the corresponding ordinary species.

Also provided are novel compounds and molecular ions comprising

(a) a plurality of neutral, positive, or negative species (hereinafter “increased binding energy species”) having a total energy
(i) greater than the total energy of the ordinary molecular species, or
(ii) greater than the total energy of any species for which the corresponding ordinary species is unstable or is not observed because the ordinary species' total energy is less than thermal energies at ambient conditions or is negative; and

(b) optionally one other element. The compounds of the invention are hereinafter referred to as “increased binding energy compounds”.

The total energy of the increased total energy species is the sum of the energies to remove all of the electrons from the increased total energy species. The total energy of the ordinary species is the sum of the energies to remove all of the electrons from the ordinary species. The increased total energy species is referred to as an increased binding energy species, even though some of the increased binding energy species may have a first electron binding energy less than the first electron binding energy of the ordinary molecular species. However, the total energy of the increased binding energy species is much greater than the total energy of the ordinary molecular species.

In a preferred embodiment the catalysis of a one electron atom having an initial binding energy given by

Binding Energy=q² 13.6 eV (10)

forms an increased binding energy one electron atom having a binding energy given by

$$Binding Energy = \frac{{q}^{2} 13.6 eV}{( \frac{1}{p} )} \qquad ( 11 )$$

where p is an integer greater than 1, preferably from 2 to 200 and q is the nuclear charge of the ordinary one electron atom (e.g. q=2 for H^{e+}).

The increased binding energy compounds of the present invention are capable of exhibiting one or more unique properties which distinguishes them from the corresponding compound comprising ordinary species, if such ordinary compound exists. The unique properties include, for example, (a) a unique stoichiometry; (b) unique chemical structure; (c) one or more extraordinary chemical properties such as conductivity, melting point, boiling point, density, and refractive index; (d) unique reactivity to other elements and compounds; (e) enhanced stability at room temperature and above; and/or (f) enhanced stability in air and/or water. Methods for distinguishing the increased binding energy compounds from ordinary compounds: 1.) elemental analysis, 2.) solubility, 3.) reactivity, 4.) melting point, 5.) boiling point, 6.) vapor pressure as a function of temperature, 7.) refractive index, 8.) X-ray photoelectron spectroscopy (XPS), 9.) gas chromatography, 10.) X-ray diffraction (XRD), 11.) calorimetry, 12.) infrared spectroscopy (IR), 13.) Raman spectroscopy, 14.) Mossbauer spectroscopy, 15.) extreme ultraviolet (EUV) emission and absorption spectroscopy, 16.) ultraviolet (UV) emission and absorption spectroscopy, 17.) visible emission and absorption spectroscopy, 18.) nuclear magnetic resonance spectroscopy, 19.) gas phase mass spectroscopy of a heated sample (solids probe and direct exposure probe quadrapole and magnetic sector mass spectroscopy), 20.) time-of-flight-secondary-ion-massspectroscopy (TOFSIMS), 21.) electrospray-ionization-time-offlight-mass-spectroscopy (ESITOFMS), 22.) thermogravimetric analysis (TGA), 23.) differential thermal analysis (DTA), 24.) differential scanning calorimetry (DSC), 25.) liquid chromatography/mass spectroscopy (LCMS), and/or 26.) gas chromatography/mass spectroscopy (GCMS).

The compounds of the present invention are preferably greater than 50 atomic percent pure. More preferably, the compounds are greater than 90 atomic percent pure. Most preferably, the compounds are greater than 98 atomic percent pure.

A method is provided for preparing increased binding energy compounds. The method comprises reacting one electron atoms with a catalyst having a net enthalpy of reaction of about m 0.27 eV, where m is an integer greater than 1, preferably an 2 integer less than 400, to produce increased binding energy one electron atoms. The increased binding energy one electron atoms can be reacted further to form increased binding energy one electron atom species by reacting one or more increased binding energy one electron atoms with one or more of an increased binding energy one electron atom or species, a compound containing at least one of said increased binding energy one electron atom or species, and at least one other atom, molecule, or ion other than an increased binding energy one electron atom or species. An increased binding energy one electron atom or species can be reacted with one or more electrons from an electron source to form a positive, neutral, or negative species (hereinafter “increased binding energy species”). A further product of the catalysis is energy. At least one selected from the group of increased binding energy one electron atom, increased binding energy one electron atom species, or increased binding energy species can be reacted with another element to form an increased binding energy’ compound.

The invention is also directed to a reactor for producing increased binding energy compounds of the invention. A further product of the catalysis is energy. The reactor comprises a cell for making increased binding energy one electron atoms, and in addition, the reactor may comprise an electron source. The cell for making increased binding energy one electron atoms may take the form of an electrolytic cell, a gas cell, a gas discharge cell, or a plasma torch cell, for example. Each of these cells comprises: a source of one electron atom; at least one of a solid, molten, liquid, or gaseous catalyst for making increased binding energy one electron atoms; and a vessel for reacting one electron atoms and the catalyst for making increased binding energy one electron atoms. The reactors described herein may also produce increased binding energy one electron atom species, increased binding energy species, and increased binding energy compounds by providing the appropriate reactants to the cell form a source of reactant. A reactant of the present invention to form increased binding energy one electron atom species, increased binding energy species, and increased binding energy compounds is an increased binding energy hydrogen species given in Mills Prior Publications which are herein incorporated by reference. They may formed within the reactor along with one or more selected from the group of increased binding energy one electron atom species, increased binding energy species, and increased binding energy compounds by methods given in Mills Prior Publications which are herein incorporated by reference. Or they may be supplied from a source of increased binding energy species and increased binding energy compounds.

### Catalysts

A catalyst of the present invention of a novel catalytic reaction to produce increased binding energy one electron atoms is a hydrino atom having a binding energy given by Eq. (1) which provides a net enthalpy of reaction of about

$$\frac{m}{2} \cdot 27 eV ,$$

where m is an integer greater than 1, preferably an integer less than 400.

Catalysts are given in Mills Prior Publications which are herein incorporated by reference. Some additional examples are given. infra.

### t Electron Transfer (One Species)

In another embodiment, a catalytic system is provided by the ionization of t electrons from a participating species such as an atom, an ion, a molecule, and an ionic or molecular compound to a continuum energy level such that the sum of the ionization energies of the t electrons is approximately m×27.2 eV where m is an integer. One such catalytic system involves iron. The first, second, and third ionization energies of iron are 7.9024. 16.1878 eV, and 30.652 eV, respectively [David R. Linde, CRC Handbook of Chemistry and Physics, 74 th Edition, CRC Press, Boca Raton, Fla., (1993), p. 10-207]. The triple ionization (t=3) reaction of Fe to Fe³⁺+, then, has a net enthalpy of reaction of 54.7 eV, which is equivalent to m=2 in Eq. (2). The catalysis reaction of iron with ordinary He⁺ is given by

$$\begin{matrix}54.7 eV + Fe ( m ) + {He}^{+} [ \frac{{a}_{H}}{2} ] -> {Fe}^{3 +} + 3 {e}^{-} + {He}^{+} [ \frac{{a}_{H}}{3} ] + [ {3}^{2} - {2}^{2} ] \times 13.6 eV & ( 12 ) \\ {Fe}^{3 +} \times 3 {e}^{-} -> Fe ( m ) + 54.7 eV & ( 13 )\end{matrix}$$

And, the overall reactions is

$${He}^{+} [ \frac{{a}_{H}}{2} ] -> {He}^{+} [ \frac{{a}_{H}}{3} ] + [ {3}^{2} - {2}^{2} ] \times 13.6 eV \qquad ( 14 )$$

Further catalysis of increased binding energy helium ion may occur to lower energy states according to the reactions given for hydrogen in Mills Prior Publications except that increased binding energy helium replaces increased binding energy hydrogen.

One electron atom catalysts capable of providing a net enthalpy of reaction of approximately m×27.2 eV where m is an integer to produce increased binding energy one electron atoms whereby t electrons are ionized from an atom or ion are given infra. A further product of the catalysis is energy. The atoms or ions given in the first column are ionized to provide the net enthalpy of reaction of m×27.2 eV given in the tenth column where m is given in the eleventh column. The electrons which are ionized are given with the ionization potential (also called ionization energy or binding energy). The ionization potential of the nth electron of the atom or ion is designated by IP, and is given by David R. Linde, CRC Handbook of Chemistry and Physics, 78 th Edition, CRC Press, Boca Raton, Fla., (1997), p. 10-214 to 10-216 which is herein incorporated by reference. That is for example, Fe+7.9024 eV→Fe⁺+e⁻, Fe⁺+16.1878 eV→Fe²⁺+e⁻, and Fe²⁺+30.652 eV→Fe³⁺+e⁻. The first ionization potential, IP₁.=7.9024 eV, the second ionization potential, IP₂=16.1878 eV, and the third ionization potential, IP₃=30.652 eV are given in the second, third, and fourth columns, respectively. The net enthalpy of reaction for the triple ionization of Fe is 54.7 e V as given in the tenth column, and m=2 in Eq. (2) as given in the eleventh column.

| Catalyst | IP1 | IP2 | IP3 | IP4 | IP5 | IP6 | IP7 | IP8 | Enthalpy | m |
|---|---|---|---|---|---|---|---|---|---|---|
| Li | 5.39172 | 75.6402 | | | | | | | 81.032 | 3 |
| Be | 9.32263 | 18.2112 | | | | | | | 27.534 | 1 |
| K | 4.34065 | 31.63 | 46.806 | | | | | | 81.777 | 3 |
| Ca | 6.11316 | 11.8717 | 50.9131 | 67.27 | | | | | 136.17 | 5 |
| Ti | 6.8282 | 13.5755 | 27.4917 | 43.267 | 99.3 | | | | 190.46 | 7 |
| V | 6.7463 | 14.66 | 29.311 | 46.709 | 65.2817 | | | | 162.71 | 6 |
| Cr | 6.76664 | 16.4857 | 30.96 | | | | | | 54.212 | 2 |
| Mn | 7.43402 | 15.64 | 33.668 | 51.2 | | | | | 107.94 | 4 |
| Fe | 7.9024 | 16.1878 | 30.652 | | | | | | 54.742 | 2 |
| Fe | 7.9024 | 16.1878 | 30.652 | 54.8 | | | | | 109.54 | 4 |
| Co | 7.881 | 17.083 | 33.5 | 51.3 | | | | | 109.76 | 4 |
| Co | 7.881 | 17.083 | 33.5 | 51.3 | 79.5 | | | | 189.26 | 7 |
| Ni | 7.6398 | 18.1688 | 35.19 | 54.9 | 76.06 | | | | 191.96 | 7 |
| Ni | 7.6398 | 16.1688 | 35.19 | 54.9 | 76.06 | 108 | | | 299.96 | 11 |
| Cu | 7.72638 | 20.2924 | | | | | | | 28.019 | 1 |
| Zn | 9.39405 | 17.9644 | | | | | | | 27.356 | 1 |
| Zn | 9.39405 | 17.9644 | 39.723 | 59.4 | 82.6 | 108 | 134 | 174 | 625.08 | 23 |
| As | 9.8152 | 18.633 | 28.351 | 50.13 | 62.63 | 127.6 | | | 297.16 | 11 |
| Se | 9.75238 | 21.19 | 30.8204 | 42.945 | 68/3 | 81.7 | 155.4 | | 410.11 | 15 |
| Kr | 13.9996 | 24.3599 | 36.95 | 52.5 | 64.7 | 78.5 | | | 271.01 | 10 |
| Kr | 13.9996 | 24.3599 | 36.95 | 52.5 | 64.7 | 76.5 | 111 | | 382.01 | 14 |
| Rb | 4.17713 | 27.285 | 40 | 42.6 | 71 | 84.4 | 99.2 | | 378.66 | 14 |
| Rb | 4.17713 | 27.285 | 40 | 52.6 | 71 | 84.4 | 99.2 | 135 | 514.66 | 19 |
| Sr | 5.69484 | 11.0301 | 42.89 | 57 | 71.6 | | | | 188.21 | 7 |
| Nb | 6.75885 | 14.32 | 25.04 | 38.3 | 50.55 | | | | 134.97 | 5 |
| No | 7.09243 | 16.16 | 27.13 | 46.4 | 54.49 | 68.8276 | | | 151.27 | 8 |
| Mo | 7.09243 | 16.16 | 27.13 | 46.4 | 54.49 | 68.8276 | 125.664 | 143.6 | 489.36 | 18 |
| Pd | 8.3369 | 19.43 | | | | | | | 27.767 | 1 |
| Sn | 7.34381 | 14.6323 | 30.5026 | 40.735 | 72.28 | | | | 165.49 | 6 |
| Te | 9.0096 | 18.6 | | | | | | | 27.61 | 1 |
| Te | 9.0096 | 18.6 | 27.96 | | | | | | 55.57 | 2 |
| Cs | 3.6939 | 23.1575 | | | | | | | 27.051 | 1 |
| Ce | 5.5387 | 10.85 | 20.198 | 36.758 | 65.55 | | | | 138.89 | 5 |
| Ce | 5.5387 | 10.85 | 20.198 | 36.758 | 65.55 | 77.5 | | | 216.49 | 8 |
| Pr | 5.464 | 10.55 | 21.624 | 38.98 | 57.53 | | | | 134.15 | 1 |
| Sm | 5.6437 | 11.07 | 23.4 | 41.4 | | | | | 81.514 | 3 |
| Gd | 6.15 | 12.09 | 20.63 | 44 | | | | | 82.87 | 3 |
| Dy | 5.9369 | 11.67 | 22.8 | 41.47 | | | | | 81.879 | 3 |
| Pb | 7.41666 | 15.0322 | 31.9373 | | | | | | 54.386 | 2 |
| Pt | 8.9587 | 16.553 | | | | | | | 27.522 | 1 |
| He+ | | 54.4178 | | | | | | | 54.418 | 2 |
| Rb+ | | 27.285 | | | | | | | 27.285 | 1 |
| Fe3+ | | | | 54.8 | | | | | 54.8 | 2 |
| Mo2+ | | | 27.13 | | | | | | 27.13 | 1 |
| Mo4+ | | | | | 54.49 | | | | 54.49 | 2 |
| In3+ | | | | 54 | | | | | 54 | 2 |

### Molecular Catalysts

The ionization energies of molecules are given by David R. Linde, CRC Handbook of Chemistry and Physics, 79 th Edition, CRC Press, Boca Raton, Fla., (1998), p. 10-178 to 10-195. For example, the gasphase ionization energy of MgF₂ is 13.6±0.3 eV. Thus, the ionization of two MgF₂ provides an net enthalpy of +27.2 eV and serves as a one electron atom catalyst.

### Reactor

Reactors to form increased binding energy one electron atoms, increased binding energy one electron atom species, increased binding energy species, and increased binding energy compounds are described in Mills Prior Publications which are herein incorporated by reference. Some examples are given infra.

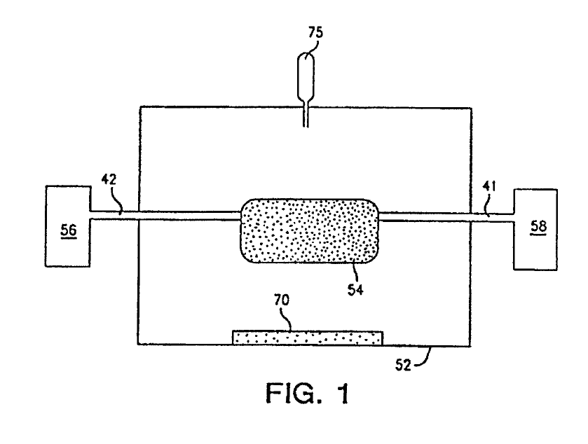

One embodiment of the present invention involves a reactor shown in FIG. 1, comprising a vessel 52 containing a catalysis mixture 54. The catalysis mixture 54 comprises a source of one electron atom 56 supplied through supply passage 42 and a catalyst 58 supplied through catalyst supply passage 41. Catalyst 58 has a net enthalpy of reaction of about

$$\frac{m}{2 } 27.21 eV ,$$

where m is 2 an integer, preferably an integer less than 400. The catalysis involves reacting one electron atoms from the source 56 with the catalyst 58 to form increased binding energy one electron atoms. The reactor may further include an electron source 70 for contacting increased binding energy one electron atoms with electrons, to reduce them to increased binding energy species.

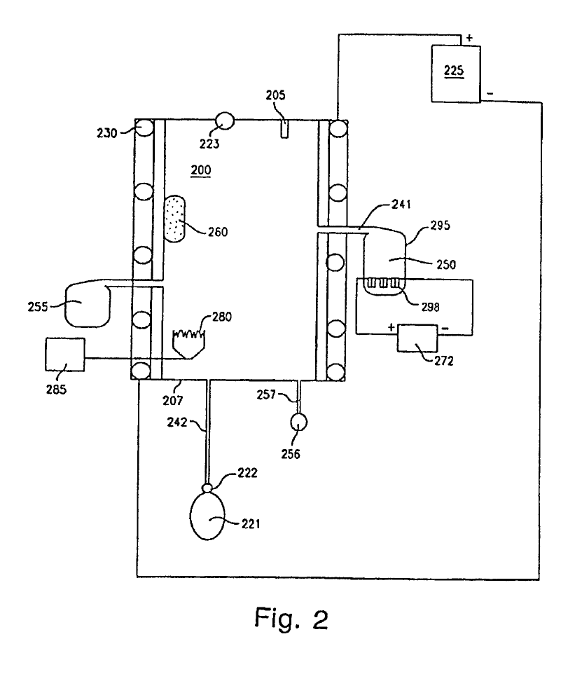

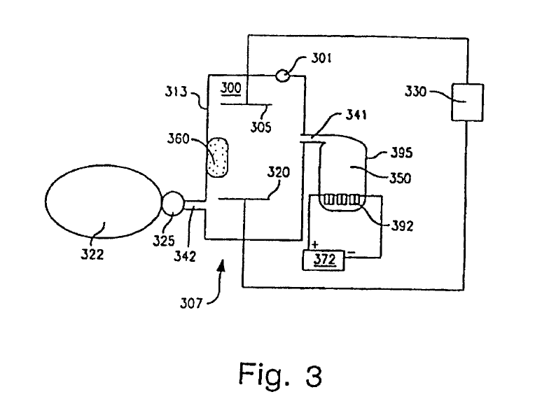

According to another embodiment of the invention utilizing a gas cell reactor or gas discharge cell reactor as shown in FIGS. 2 and 3, respectively, a photon source ionizes a source of one electron atoms to one electron atoms.

In all the reactor embodiments of the present invention, the means to form increased binding energy one electron atoms can be one or more of an electrochemical, chemical, photochemical, thermal, free radical, sonic, or nuclear reaction(s), or inelastic photon or particle scattering reaction(s). In the latter two cases, the reactor comprises a particle source and/or photon source 75 as shown in FIG. 1, to supply the reaction as an inelastic scattering reaction. In one embodiment of the reactor, the catalyst includes an electrocatalytic ion or couple(s) in the molten, liquid, gaseous, or solid state given in the Tables of the Prior Mills Publications which are herein incorporated by reference (e.g. TABLE 4 of PCT/US90/01998 and pages 25-46, 80-108 of PCT/US94/02219).

Where the catalysis occurs in the gas phase, the catalyst may be maintained at a pressure less than atmospheric, preferably in the range 10 millitorr to 100 torr. The source of one electron atom and the one electron atom reactant is maintained at a pressure less than atmospheric, preferably in the range 10 millitorr to 100 torr.

Each of the reactor embodiments of the present invention (gas cell reactor, gas discharge cell reactor, and plasma torch cell reactor) comprises the following: a source of one electron atom; at least one of a solid, molten, liquid, or gaseous catalyst for generating increased binding energy one electron atoms; and a vessel for containing the one electron atoms and the catalyst.

Methods and apparatus for producing increased binding energy one electron atoms, including a listing of effective catalysts, are described in the Prior Mills Publications which are herein incorporated by reference. The increased binding energy one electron atoms so produced react with the electrons to form increased binding energy species. Methods to reduce increased binding energy one electron atoms include, for example, the following: in the gas cell reactor, chemical reduction by a reactant; in the gas discharge cell reactor, reduction by the plasma electrons or by the cathode of the gas discharge cell; in the plasma torch reactor, reduction by plasma electrons.

### Gas Cell Reactor

According to another embodiment of the invention, a reactor for producing increased binding energy one electron atoms may take the form of a gas cell reactor. A gas cell reactor of the present invention is shown in FIG. 2. Catalysis may occur in the gas phase.

The reactor of FIG. 2 comprises a reaction vessel 207 having a chamber 200 capable of containing a vacuum or pressures greater than atmospheric. A source of one electron atoms 221 communicating with chamber 200 delivers a source of one electron atoms to the chamber through supply passage 242. A controller 222 is positioned to control the pressure and flow of a source of one electron atoms into the vessel through supply passage 242. A pressure sensor 223 monitors pressure in the vessel. A vacuum pump 256 is used to evacuate the chamber through a vacuum line 257. The apparatus further comprises a source of electrons in contact with the increased binding energy one electron atoms to form increased binding energy species.

A catalyst 250 for generating increased binding energy one electron atoms can be placed in a catalyst reservoir 295. The catalyst in the gas phase may comprise the electrocatalytic ions and couples described in the Mills Prior Publications which are herein incorporated by reference. The reaction vessel 207 has a catalyst supply passage 241 for the passage of gaseous catalyst from the catalyst reservoir 295 to the reaction chamber 200. Alternatively, the catalyst may be placed in a chemically resistant open container, such as a boat, inside the reaction vessel.

The source of one electron atoms and one electron atom partial pressures in the reactor vessel 207, as well as the catalyst partial pressure, is preferably maintained in the range of 10 millitorr to 100 torr. Most preferably, the source of one electron atoms partial pressure in the reaction vessel 207 is maintained at about 200 millitorr.

The source of one electron atom may be ionized in the vessel into one electron atoms by an ionizing material. The ionizing material may comprise, for example, a noble metal such as platinum or palladium, a transition metal such as nickel and titanium, an inner transition metal such as niobium and zirconium, or a refractory metal such as tungsten or molybdenum. The ionizing material may be maintained at an elevated temperature by the heat liberated by the catalysis. The ionizing material may also be maintained at elevated temperature by temperature control means 230, which may take the form of a heating coil as shown in cross section in FIG. 2. The heating coil is powered by a power supply 225.

The source of one electron atoms may be ionized into one electron atoms by application of electromagnetic radiation, such as UV light provided by a photon source 205

The source of one electron atoms may be ionized into one electron atoms by a hot filament or grid 280 powered by power supply 285.

The ionization occurs such that the one electron atoms contact a catalyst which is in a molten, liquid, gaseous, or solid form to produce increased binding energy one electron atoms. The catalyst vapor pressure is maintained at the desired pressure by controlling the temperature of the catalyst reservoir 295 with a catalyst reservoir heater 298 powered by a power supply 272. When the catalyst is contained in a boat inside the reactor, the catalyst vapor pressure is maintained at the desired value by controlling the temperature of the catalyst boat, by adjusting the boat's power supply.

The rate of production of increased binding energy one electron atoms by the gas cell reactor can be controlled by controlling the amount of catalyst in the gas phase and/or by controlling the concentration of one electron atoms. The rate of production of increased binding energy species can be controlled by controlling the concentration of increased binding energy one electron atoms, such as by controlling the rate of production of increased binding energy one electron atoms. The concentration of gaseous catalyst in vessel chamber 200 may be controlled by controlling the initial amount of the volatile catalyst present in the chamber 200. The concentration of gaseous catalyst in chamber 200 may also be controlled by controlling the catalyst temperature, by adjusting the. catalyst reservoir heater 298, or by adjusting a catalyst boat heater when the catalyst is contained in a boat inside the reactor. The vapor pressure of the volatile catalyst 250 in the chamber 200 is determined by the temperature of the catalyst reservoir 295, or the temperature of the catalyst boat, because each is colder than the reactor vessel 207. The reactor vessel 207 temperature is maintained at a higher operating temperature than catalyst reservoir 295 with heat liberated by the catalysis. The reactor vessel temperature may also be maintained by a temperature control means, such as heating coil 230 shown in cross section in FIG. 2. Heating coil 230 is powered by power supply 225. The reactor temperature further controls the reaction rates such as ionization of the source of one electron atoms and catalysis.

In another embodiment, the source of one electron atoms is added to the cell 1.) as a solid, 2.) as a vaporized solid with the catalyst by mixing it with the catalyst in the catalyst reservoir 295 or boat, or 3.) the source of one electron atoms is added to the cell separately through a reservoir and passage similar to those of the catalyst. In the later two cases, the vapor pressure of the source of one electron atoms may be controlled by controlling the temperature of the reservoir. Source 221 may serve as such a reservoir.

The preferred operating temperature depends, in part, on the nature of the material comprising the reactor vessel 207. The temperature of a stainless steel alloy reactor vessel 207 is preferably maintained at 200-1200° C. The temperature of a molybdenum reactor vessel 207 is preferably maintained at 200-1800° C. The temperature of a tungsten reactor vessel 207 is preferably maintained at 200-3000° C. The temperature of a quartz or ceramic reactor vessel 207 is preferably maintained at 200-1800° C.

The concentration of one electron atoms in vessel chamber 200 can be controlled by the amount of one electron atoms generated by the ionization material. The rate of ionization is controlled by controlling the surface area, the temperature, and the selection of the ionization material. The concentration of one electron atoms may also be controlled by the amount of the source of one electron atoms provided by the source 280. The concentration of one electron atoms can be further controlled by the amount of the source of one electron atoms supplied from the source 221 controlled by a flow controller 222 and a pressure sensor 223. The reaction rate may be monitored by windowless extreme ultraviolet (EUV) emission spectroscopy to detect the intensity of the EUV emission due to the catalysis, increased binding energy one electron atom, increased binding energy species, and increased binding compound emissions.

The gas cell reactor further comprises an electron source 260 in contact with the generated increased binding energy one electron atoms to form increased binding energy species. In the gas cell reactor of FIG. 2, increased binding energy one electron atoms are reduced to increased binding energy species by contacting a reductant comprising the reactor vessel 207. Alternatively, reduction occurs by contact with any of the reactor's components, such as, photon source 205, catalyst 250, catalyst reservoir 295, catalyst reservoir heater 298, hot filament grid 280, pressure sensor 223, source of one electron atoms 221, flow controller 222, vacuum pump 256, vacuum line 257, catalyst supply passage 241, or supply passage 242. Increased binding energy one electron atoms may also be reduced by contact with a reductant extraneous to the operation of the cell (i.e. a consumable reductant added to the cell from an outside source). Electron source 260 is such a reductant.

Increased binding energy compounds may be formed in the gas cell. The other element of the compound may comprise a cation or anion of the material of the cell, a cation or anion comprising the ionizing material which produces one electron atoms, a cation or anion comprising an added reductant or oxidant, or a cation or anion present in the cell (such as the cation or anion of the catalyst).

### Gas Discharge Cell Reactor

A gas discharge cell reactor of the present invention is shown in FIG. 3. The gas discharge cell reactor of FIG. 3, includes a gas discharge cell 307 comprising a gas-filled glow discharge vacuum vessel 313 having a chamber 300. A source of one electron atoms 322 supplies a source of or supplies one electron atoms to the chamber 300 through control valve 325 via a supply passage 342. A catalyst for generating increased binding energy one electron atoms, such as the compounds described in Mills Prior Publications which are herein incorporated by reference (e.g. TABLE 4 of PCT/US90/01998 and pages 25-46, 80-108 of PCT/US94/02219) is contained in catalyst reservoir 395. A voltage and current source 330 causes current to pass between a cathode 305 and an anode 320. The current may be reversible.

In one embodiment of the gas discharge cell reactor, the wall of vessel 313 is conducting and serves as the anode. In another embodiment, the cathode 305 is hollow such as a hollow, nickel, aluminum, copper, or stainless steel hollow cathode.

The cathode 305 may be coated with the catalyst for generating increased binding energy one electron atoms. The catalysis to form increased binding energy one electron atoms may occur on the electrode surface. To form one electron atoms, the source is ionized at the anode, a nucleus is reduced at the cathode, or ionization or reduction occurs by the discharge.

According to another embodiment of the invention, the catalyst for generating increased binding energy one electron atoms is in gaseous form. For example, the discharge may be utilized to vaporize the catalyst to provide a gaseous catalyst. Alternatively, the gaseous catalyst is produced by the discharge current. The gaseous one electron atoms for reaction with the gaseous catalyst are provided by a discharge of a gaseous source of one electron atoms such that the catalysis occurs in the gas phase.

Another embodiment of the gas discharge cell reactor where catalysis occurs in the gas phase utilizes a controllable gaseous catalyst. The gaseous one electron atoms for conversion to increased binding energy one electron atoms are provided by a discharge of a gaseous source of one electron atoms. The gas discharge cell 307 has a catalyst supply passage 341 for the passage of the gaseous catalyst 350 from catalyst reservoir 395 to the reaction chamber 300. The catalyst reservoir 395 is heated by a catalyst reservoir heater 392 having a power supply 372 to provide the gaseous catalyst to the reaction chamber 300. The catalyst vapor pressure is controlled by controlling the temperature of the catalyst reservoir 395, by adjusting the heater 392 by means of its power supply 372. The reactor further comprises a selective venting valve 301.

In another embodiment of the gas discharge cell reactor where catalysis occurs in the gas phase utilizes a controllable gaseous catalyst. Gaseous one electron atoms are provided by a discharge of a gaseous source of one electron atoms. A chemically resistant (does not react or degrade during the operation of the reactor) open container, such as a tungsten or ceramic boat, positioned inside the gas discharge cell contains the catalyst. The catalyst in the catalyst boat is heated with a boat heater using by means of an associated power supply to provide the gaseous catalyst to the reaction chamber. Alternatively, the glow gas discharge cell is operated at an elevated temperature such that the catalyst in the boat is sublimed, boiled, or volatilized into the gas phase. The catalyst vapor pressure is controlled by controlling the temperature of the boat or the discharge cell by adjusting the heater with its power supply.

In another embodiment, the source of one electron atoms is added to the cell 1.) as a solid, 2.) as a vaporized solid with the catalyst by mixing it with the catalyst in the catalyst reservoir 395 or a boat, or 3.) the source of one electron atoms is added to the cell separately through a reservoir and passage similar to those of the catalyst. In the later two cases, the vapor pressure of the source of one electron atoms may be controlled by controlling the temperature of the reservoir. Source 322 nay serve as such a reservoir.

The gas discharge cell may be operated at room temperature by continuously supplying catalyst. Alternatively, to prevent the catalyst from condensing in the cell, the temperature is maintained above the temperature of the catalyst source, catalyst reservoir 395 or catalyst boat. For example, the temperature of a stainless steel alloy cell is 0-1200° C.; the temperature of a molybdenum cell is 0-1800° C.; the temperature of a tungsten cell is 0-3000° C.; and the temperature of a glass, quartz, or ceramic cell is 0-1800° C. The discharge voltage may be in the range of 1000 to 50,000 volts. The current may be in the range of 1 μA to 1 A, preferably about 1 mA

In a further embodiment, the gas discharge cell apparatus includes an electron source in contact with the increased binding energy one electron atoms, in order to generate increased binding energy species. The increased binding energy one electron atoms are reduced to increased binding energy species by contact with cathode 305, with plasma electrons of the discharge, or with the vessel 313. Also, increased binding energy one electron atoms may be reduced by contact with any of the reactor components, such as anode 320, catalyst 350, heater 392, catalyst reservoir 395, selective venting valve 301, control valve 325, source of one electron atoms 322, supply passage of source of one electron atoms 342 or catalyst supply passage 341. According to yet another variation, increased binding energy one electron atoms are reduced by a reductant 360 extraneous to the operation of the cell (e.g. a consumable reductant added to the cell from an outside source).

Increased binding energy compounds may be formed in the gas discharge cell. The compound may comprise an oxidized or reduced species of the material comprising the cathode or the anode, a cation or anion of an added reductant, or a cation or anion present in the cell (such as a cation or anion of the catalyst).

In one embodiment of the gas discharge cell apparatus, potassium metal serves as the catalysts. The catalyst reservoir 395 contains potassium metal catalyst. The catalyst vapor pressure in the gas discharge cell is controlled by heater 392. The catalyst reservoir 395 is heated with the heater 392 to maintain the catalyst vapor pressure proximal to the cathode 305 preferably in the pressure range 10 millitorr to 100 torr, more preferably at about 200 mtorr. In another embodiment, the cathode 305 and the anode 320 of the gas discharge cell 307 are coated with catalyst. The catalyst is vaporized during the operation of the cell. The source of one electron atoms supply from source 322 is adjusted with control 325 to supply and maintain the source of one electron atom pressure in the 10 millitorr to 100 torr range.

In one embodiment of the gas discharge cell reactor apparatus, catalysis occurs in a gas discharge cell using a catalyst with a net enthalpy of about 27.2 electron volts. The catalyst (e.g. potassium metal) is vaporized by the discharge. The discharge also produces reactant one electron atoms. Catalysis using potassium results in the emission of extreme ultraviolet (UV) photons. Thus, the extreme UV emission from the catalysis is observable. These lines are observable by emission spectroscopy which identify catalysis and increased binding energy compounds. The emission may be used to monitor the reaction.

### Plasma Torch Cell Reactor

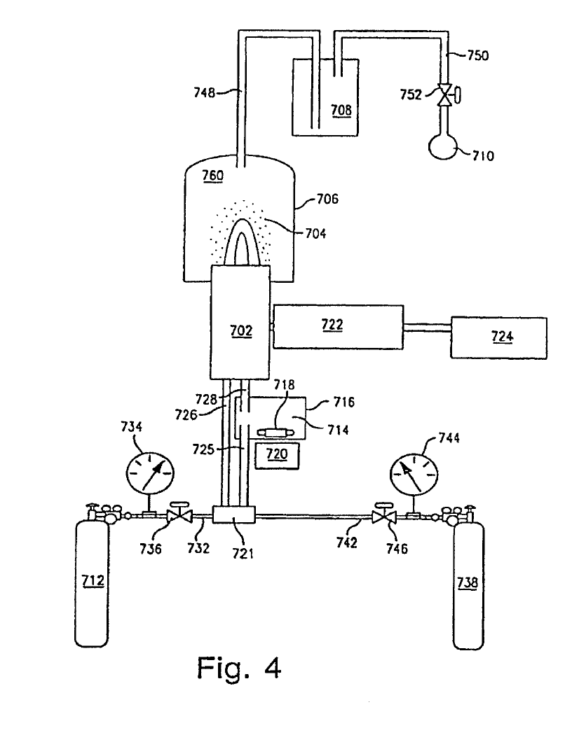

A plasma torch cell reactor of the present invention is shown in FIG. 4. A plasma torch 702 provides a plasma 704 enclosed by a manifold 706. A source of one electron atoms from supply 738 and plasma gas from plasma gas supply 712, along with a catalyst 714 for forming increased binding energy one electron atoms, is supplied to torch 702. The plasma may comprise argon, for example. The catalyst may comprise any of the compounds described in Mills Prior Publications which are herein incorporated by reference (e.g. TABLE 4 of PCT/US90/01998 and pages 25-46, 80-108 of PCT/US94/02219). The catalyst is contained in a catalyst reservoir 716. The reservoir is equipped with a mechanical agitator, such as a magnetic stirring bar 718 driven by magnetic stirring bar motor 720. The catalyst is supplied to plasma torch 702 through passage 728.

A source of one electron atoms is supplied to the torch 702 by a passage 726. Alternatively, both a source of one electron atoms and catalyst may be supplied through passage 728. The plasma gas is supplied to the torch by a plasma gas passage 726. Alternatively, both plasma gas and catalyst may be supplied through passage 728.

In one embodiment, a source of one electron atoms flows from supply 738 to a catalyst reservoir 716 via passage 742. The flow of the source of one electron atoms is controlled by flow controller 744 and valve 746. Plasma gas flows from the plasma gas supply 712 via passage 732. The flow of plasma gas is controlled by plasma gas flow controller 734 and valve 736. A mixture of plasma gas and the source of one electron atoms is supplied to the torch via passage 726 and to the catalyst reservoir 716 via passage 725. The mixture is controlled by a source of one electron atoms-plasma-gas mixer and mixture flow regulator 721. The source of one electron atoms and plasma gas mixture serves as a carrier gas for catalyst particles which are dispersed into the gas stream as fine particles by mechanical agitation. The aerosolized catalyst and source of one electron atoms of the mixture flow into the plasma torch 702 and become gaseous one electron atoms and vaporized catalyst (such as potassium metal) in the plasma 704. The plasma is powered by a microwave generator 724 wherein the microwaves are tuned by a tunable microwave cavity 722. Catalysis occurs in the gas phase.

The amount of gaseous catalyst in the plasma torch is controlled by controlling the rate that catalyst is aerosolized with the mechanical agitator. The amount of gaseous catalyst is also controlled by controlling the carrier gas flow rate where the carrier gas includes a source of one electron atoms and plasma gas mixture (e.g., helium and argon). The amount of one electron atoms to the plasma torch is controlled by controlling the flow rate of the source of one electron atoms and the ratio of the source of one electron atoms to plasma gas in the mixture. The flow rate of the source of one electron atoms and the plasma gas flow rate to the source of one electron atoms-plasma-gas mixer and mixture flow regulator 721 are controlled by flow rate controllers 734 and 744, and by valves 736 and 746. Mixer regulator 721 controls the source of one electron atoms-plasma mixture to the torch and the catalyst reservoir. The catalysis rate is also controlled by controlling the temperature of the plasma with microwave generator 724.

In another embodiment, the source of one electron atoms is added to the cell 1.) as a solid, 2.) as an aerosolized solid with the catalyst by mixing it with the catalyst in the catalyst reservoir 716, or 3.) the source of one electron atoms is added to the cell separately through a reservoir and passage similar to those of the catalyst.

Increased binding energy one electron atoms and increased binding energy species are produced in the plasma 704. Increased binding energy compounds are cryopumped onto the manifold 706, or they flow into compound trap 708 through passage 748. Trap 708 communicates with vacuum pump 710 through vacuum line 750 and valve 752. A flow to the trap 708 is effected by a pressure gradient controlled by the vacuum pump 710, vacuum line 750, and vacuum valve 752.

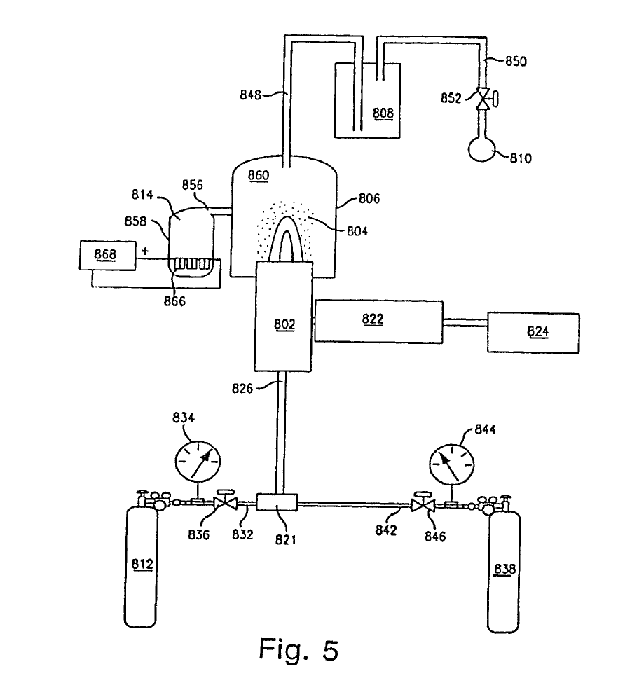

In another embodiment of the plasma torch cell reactor shown in FIG. 5, at least one of plasma torch 802 or manifold 806 has a catalyst supply passage 856 for passage of the gaseous catalyst from a catalyst reservoir 858 to the plasma 804. The catalyst in the catalyst reservoir 858 is heated by a catalyst reservoir heater 866 having a power supply 868 to provide the gaseous catalyst to the plasma 804. The catalyst vapor pressure is controlled by controlling the temperature of the catalyst reservoir 858 by adjusting the heater 866 with its power supply 868. The remaining elements of FIG. 5 have the same structure and function of the corresponding elements of FIG. 4. In other words, element 812 of FIG. 5 is a plasma gas supply corresponding to the plasma gas supply 712 of FIG. 4, element 838 of FIG. 5 is a supply for a source of one electron atoms corresponding to supply 738 of FIG. 4, and so forth.

In another embodiment of the plasma torch cell reactor, a chemically resistant open container such as a ceramic boat located inside the manifold contains the catalyst. The plasma torch manifold forms a cell which is operated at an elevated temperature such that the catalyst in the boat is sublimed, boiled, or volatilized into the gas phase. Alternatively, the catalyst in the catalyst boat is heated with a boat heater having a power supply to provide the gaseous catalyst to the plasma. The catalyst vapor pressure is controlled by controlling the temperature of the cell with a cell heater, or by controlling the temperature of the boat by adjusting the boat heater with an associated power supply.

In another embodiment, the source of one electron atoms is added to the cell 1.) as a solid, 2.) as a vaporized solid with the catalyst by mixing it with the catalyst in the catalyst reservoir 858 or boat, or 3.) the source of one electron atoms is added to the cell separately through a reservoir and passage similar to those of the catalyst. In the later two cases, the vapor pressure of the source of one electron atoms may be controlled by controlling the temperature of the reservoir. Source 738 and 838 may serve as such a reservoir.

The plasma temperature in the plasma torch cell reactor is advantageously maintained in the range of 5,000-30,000° C. The cell may be operated at room temperature by continuously supplying catalyst. Alternatively, to prevent the catalyst from condensing in the cell, the cell temperature is maintained above that of the catalyst source, catalyst reservoir 758 or catalyst boat. The operating temperature depends, in part, on the nature of the material comprising the cell. The temperature for a stainless steel alloy cell is preferably 0-1200° C. The temperature for a molybdenum cell is preferably 0-1800° C. The temperature for a tungsten cell is preferably 0-3000° C. The temperature for a glass, quartz, or ceramic cell is preferably 0-1800° C. Where the manifold 706 is open to the atmosphere, the cell pressure is atmospheric.

An exemplary plasma gas for the plasma torch reactor is argon. Exemplary aerosol flow rates are 0.8 standard liters per minute (slm) source of one electron atoms (e.g. helium) and 0.15 slm argon. An exemplary argon plasma flow rate is 5 slm. An exemplary forward input power is 1000 W, and an exemplary reflected power is 10-20 W.

In other embodiments of the plasma torch reactor, the mechanical catalyst agitator (magnetic stirring bar 718 and magnetic stirring bar motor 720) is replaced with an aspirator, atomizer, or nebulizer to form an aerosol of the catalyst 714 dissolved or suspended in a liquid medium such as water. The medium is contained in the catalyst reservoir 716. Or, the aspirator, atomizer, or nebulizer injects the catalyst directly into the plasma 704. The nebulized or atomized catalyst is carried into the plasma 704 by a carrier gas.

The plasma torch reactor further includes an electron source in contact with the increased binding energy one electron atoms, for generating increased binding energy species. In the plasma torch cell, the increased binding energy one electron atoms are reduced to increased binding energy species by contacting 1.) the manifold 706, 2.) plasma electrons, or 4.) any of the reactor components such as plasma torch 702, catalyst supply passage 756, or catalyst reservoir 758, or 5) a reductant extraneous to the operation of the cell (e.g. a consumable reductant added to the cell from an outside source).

Increased binding energy compounds may be formed in the cell. The cation or anion which forms the compound may comprise a cation or anion of reacted species of the material forming the torch or the manifold, a cation or anion of an added reductant or oxidant, or a cation or anion present in the plasma (such as a cation or anion of the catalyst).

1-18. (canceled)

19. A method of making a compound comprising:
(a) a positive, negative or neutral atom having an atomic mass of at least four and having a binding energy greater than the binding energy of the corresponding atom not made by said method; and
(b) at least one other element,
said method comprising:
reacting a source of one-electron atom having an atomic mass of at least 4 with a catalyst having a net enthalpy of reaction of about m×27.2 eV, where m is an integer, to release energy from said one-electron atom and form said atom having increased binding energy; and reacting said increased binding energy species with said at least one other element to form said compound.

20. A method according to claim 19, wherein said source of one-electron atom is helium +1, having a binding energy greater than ordinary helium +1.

21. A method according to claim 19, wherein said source of one-electron atom is lithium +2, having a binding energy greater than ordinary lithium +2.

22. A method according to claim 19, wherein said source of one-electron atom is beryllium +3, having a binding energy greater than ordinary beryllium +3.

23. (canceled)

24. A method of making an increased binding energy atom having an atomic mass of at least four and having a binding energy greater than the binding energy of the corresponding ordinary atom, said method comprising:
reacting a source of one-electron atom having an atomic mass of at least 4 with a catalyst having an enthalpy of reaction of about m×27.2 eV, wherein m is an integer, to release energy from said one-electron atom and form said increased binding energy atom.

25. A method according to claim 24, wherein said source of one-electron atom is helium +1, having a binding energy greater than ordinary helium +1.

26. A method according to claim 24, wherein said source of one-electron atom is lithium +2, having a binding energy greater than ordinary lithium +2.

27. A method according to claim 24, wherein said source of one-electron atom is beryllium +3, having binding energy greater than ordinary beryllium +3.

28. (canceled)

29. A method of making an increased binding energy compound comprising:
(a) reacting a source of one-electron atom having an atomic mass of at least 4 with a catalyst having an enthalpy of reaction of about m×27.2 eV, wherein m is an integer, to form a neutral, positive or negative species having a binding greater than the species prior to said reacting; and
(b) reacting said one neutral, positive or negative increased binding energy species with at least one other element to form said compound.

30. A method according to claim 29, wherein said source of one-electron atom is helium +1.

31. A method according to claim 29, wherein said source of one-electron atom is lithium +2.

32. A method according to claim 29, wherein said source of one-electron atom is beryllium +3.

33. An increased binding energy compound made by a method according to claim 19.

34. An increased binding energy compound made by a method according to claim 23.

35. An increased binding energy compound made by a method according to claim 29.
